(19) United States
(12) Patent Application Publication
(10) Pub. No.: US 2024/0408428 A1
(43) Pub. Date: Dec. 12, 2024

(54) MAGNESIUM CHLORIDE FIRE RETARDANT COMPOSITIONS

(71) Applicant: PERIMETER SOLUTIONS LP, Clayton, MO (US)

(72) Inventors: Melissa KIM, Ontario, CA (US); Marcela MUNOZ, Fontana, CA (US); Janet SISKA, Walnut, CA (US)

(21) Appl. No.: 18/703,816

(22) PCT Filed: Mar. 31, 2023
(86) PCT No.: PCT/US2023/017068

§ 371 Date: Apr. 23, 2024

Related U.S. Application Data
(60) Provisional application No. 63/326,536, filed on Apr. 1, 2022.

(51) Int. Cl. A62D 1/00

(52) U.S. Cl. CPC A62D 1/0014; A62D 1/0035

(57) ABSTRACT

The present invention is directed to magnesium chloride fire retardant compositions, including fire retardant concentrate compositions and fire retardant solutions. In particular, the present invention is directed to solid (e.g., particulate) magnesium chloride concentrate compositions. More particularly, various aspects of the present invention are directed to powder magnesium chloride fire retardant concentrates. The present invention is also directed to methods for preparing magnesium chloride fire retardant solutions from magnesium chloride concentrate compositions of the present invention.

### REFERENCE TO RELATED APPLICATIONS

This application claims the benefit of and priority to U.S. Provisional Patent Application Ser. No. 63/326,536, filed Apr. 1, 2022, the entire contents of which are hereby incorporated by reference.

### FIELD OF THE INVENTION

The present invention is directed to magnesium chloride fire retardant compositions, including fire retardant concentrate compositions and fire retardant solutions. In particular, the present invention is directed to solid (e.g., particulate) magnesium chloride concentrate compositions. More particularly, various aspects of the present invention are directed to powder magnesium chloride fire retardant concentrates. The present invention is also directed to methods for preparing magnesium chloride fire retardant solutions from magnesium chloride concentrate compositions of the present invention.

### BACKGROUND OF THE INVENTION

Under certain circumstances, magnesium chloride may exhibit fire retardant properties. However, chlorides are widely known to be corrosive materials as stated in a report from the Environmental Protection Agency (EPA) in a report on approximately 200 airports around the country where significant deicing operations could be undertaken (“Preliminary Data Summary, Airport Deicing Operations (Revised),” Environmental Protection Agency, pg. 210, August 2022,). At least in part due to such considerations, magnesium chloride has not been adopted as a fire retardant.

The performance and corrosion issues with magnesium chloride fire retardants have been observed in connection with liquid fire retardant compositions, including concentrates. An option for magnesium chloride fire retardant compositions would be solid (e.g., powder) fire retardant compositions. However, in powder form, magnesium chloride is hygroscopic, thereby attracting water, which can lead to difficulties in storage, processing, mixing, and using. These difficulties include clumping from attracting moisture that render the powders difficult to dilute to provide the final formulation for use.

In contrast, phosphate has been the active ingredient of choice for fire retardants for decades, including long-term fire retardants and aerially applied fire retardants. This choice is based on a variety of factors, including fire retardant performance and corrosion properties of phosphate fire retardants. These performance and corrosion property benefits are provided both as compared to magnesium chloride and other fire retardants.

If magnesium chloride were selected as an alternative fire retardant the performance and corrosion issues would need to be addressed. One option would be solid (i.e., powdered) magnesium chloride fire retardants. If this option were selected, there would exist a need in the art for powdered magnesium chloride fire retardant compositions that do not clump, or aggregate together while also addressing the performance and corrosion issues with magnesium chloride as a fire retardant generally.

### BRIEF SUMMARY OF THE INVENTION

In various aspects, the present invention is directed to a powder fire retardant concentrate, the concentrate comprising: a magnesium chloride fire retardant comprising magnesium chloride hexahydrate (MgCl₂·H₂O) and/or anhydrous magnesium chloride, wherein the magnesium chloride fire retardant constitutes greater than 90 wt % of the concentrate; and a flow conditioner, wherein the flow conditioner comprises one or more selected from the group consisting of phosphate flow conditioners, oxide flow conditioners, silicate flow conditioners, silica flow conditioners, cellulose containing flow conditioners, and combinations thereof, wherein the flow conditioner constitutes from about 0.5 wt % to about 3.0 wt % of the concentrate.

In various embodiments, the concentrate comprises one or more components selected from a thickener, a corrosion inhibitor, and/or a surfactant.

In these and still other embodiments, a sample of the fire retardant concentrates exhibits a flow-function (FF-value) when tested in accordance with ASTM D-6128-16 of at least about 4. A sample exhibiting such an FF-value may be a bulk sample of more than about 100 lbs or more than about 500 lbs (e.g., at least about 1000 lbs or at least about 2000 lbs). Such a sample can also be stored for one or months and even up to a year or more and, thus, may be referred to as a stored sample.

These and various other aspects of the present invention are directed to powdered magnesium chloride fire retardants that are not contained or stored in a water/moisture-impermeable container.

The present invention is also directed to processes for preparing fire retardant solutions.

In certain embodiments, the process comprises continuously introducing a powder fire retardant concentrate into a vessel for dilution with water and forming the fire retardant solution, wherein the fire retardant concentrate is a concentrate of the present invention; and continuously mixing the powder fire retardant concentrate with the water for a mixing period, wherein the total amount of fire retardant solution produced during the mixing period is at least about 100 pounds (lbs) per minute.

In other embodiments, the process comprises combining a powder fire retardant concentrate of the present invention with water at a dilution rate of from about 0.9 lbs to about 2.0 lbs concentrate per gallon water, wherein the solution exhibits a viscosity of from about 100 centipoise (cP) to about 1500 cP.

In still further embodiments, the process comprises providing a water storage tank; providing a fire retardant concentrate storage tank, wherein the fire retardant concentrate is a powder concentrate of the present invention; conveying via a suitable conduit water from the storage tank to a vessel for storing and/or dispensing the fire retardant solution; and conveying via a suitable conduit fire retardant concentrate from the storage tank into the conduit for conveying the water to the vessel, thereby mixing the fire retardant concentrate and water. The fire retardant concentrate is conveyed via compressed air; or the fire retardant concentrate is conveyed via a pressure difference between the conduit for conveying the water and the fire retardant concentrate storage tank.

Other objects and features will be in part apparent and in part pointed out hereinafter.

### BRIEF DESCRIPTION OF THE FIGURES

FIGS. 1 and 2 provide funnel flow testing results for the formulations tested at zero hours of rest and at 72 hours of rest as discussed in Example 2.

FIGS. 3 and 4 provide unconfined yield strength test results as described in Example 2.

FIGS. 5 and 6 provide flow-function (FF-value) testing results in accordance with ASTM D-6128-16 as described in Example 2.

### DETAILED DESCRIPTION OF THE INVENTION

Generally, the present invention is directed to magnesium chloride-based fire retardants. In particular, various aspects of the present invention are directed to particulate, or powdered magnesium chloride fire retardants.

In accordance with the present invention, it has been discovered that particulate (i.e., powdered) magnesium chloride-based concentrates can be prepared that may address performance issues attendant prior magnesium chloride-based fire retardants. For example, the particulate, or powdered (e.g., flowable) concentrates of the present invention provide advantages in terms of ease of storage, storage stability, ease of mixing etc.

### Fire Retardant

The concentrates of the present invention include magnesium chloride as the fire retardant, in particular, magnesium chloride hexahydrate (MgCl₂·6H₂O), anhydrous magnesium chloride, or a combination thereof.

In various embodiments, the concentrate comprises magnesium chloride hexahydrate (MgCl₂·6H₂O) as the fire retardant. In other embodiments, the concentrate comprises anhydrous magnesium chloride as the fire retardant. In still other embodiments, the concentrate comprises both as a fire retardant.

Typically, the concentrates of the present invention include the magnesium chloride retardant (e.g., hexahydrate and/or anhydrous) in a proportion of a least about 75 wt %, at least about 80 wt %, at least about 85 wt %, at least about 90 wt %, or at least about 95 wt %. In various embodiments, the concentrates include from about 80 wt % to about 97.5 wt %, from about 85 wt % to about 97.5 wt %, or from about 90 wt % to about 97.5 wt %, (e.g., from about 90 wt % to about 95 wt %, or from about 92.5 wt % to about 97.5 wt %).

Where both magnesium chloride forms are included, typically the concentrate comprises magnesium chloride hexahydrate (MgCl₂·6H₂O) and anhydrous magnesium chloride in a weight ratio of hexahydrate to anhydrous of at least about 50:50, at least about 60:40, at least about 70:30, at least about 80:20, at least about 90:10, or at least about 95:5. In various embodiments, the weight ratio of hexahydrate to anhydrous is from about 20:80 to about 80:20, from about 30:70 to about 70:30, or from about 40:60 to about 60:40.

The magnesium chloride source may include the salt along with one or more impurities and/or other salts. Typically, the magnesium chloride source exhibits a magnesium chloride content (e.g., purity) of at least about 90 wt %, at least about 95 wt %, at least about 96 wt %, at least about 97 wt %, at least about 98 wt %, at least about 99 wt %, at least about 99.5 wt %, or even up to or at about 99.9 wt %. Therefore, the source of magnesium chloride may comprise, consist essentially of, or consist of magnesium chloride.

Commercial sources of magnesium chloride may include other components. For example, commercially available sources of magnesium chloride may be marketed as and suitable as deicers and may include a corrosion inhibitor. Such commercial sources of magnesium chloride are suitable for use in accordance with the present invention. However, it is to be understood that reference to a flow conditioner, corrosion inhibitor, etc. present in the powder concentrates of the present invention involves separate, discrete components or ingredients of the concentrate in addition to the magnesium chloride source and any components thereof.

### Additional Fire Retardants

It has been observed that magnesium chloride is less effective as a fire retardant than ammonium phosphate-based fire retardants (e.g., monoammonium phosphate (MAP), diammonium phosphate (DAP), and ammonium polyphosphate (APP)), thus requiring more retardant to provide the desired effect. To reduce the increase in fire retardant required, an ammonium phosphate-based fire retardant may be incorporated, allowing for a suitable reduction in magnesium chloride. In certain embodiments, from about 5 wt % to about 90 wt % of an ammonium phosphate fire retardant may be incorporated.

In certain embodiments, the composition comprises from about 5 wt % to about 90 wt % magnesium chloride and from about 5 wt % to about 90 wt % of ammonium phosphate-based fire retardants. The amount of each fire retardant can be selected depending on the desired balance between, for example, the amount of fire retardant to be incorporated and the desired properties to be imparted to the final composition by the individual fire retardants.

In still further embodiments, the fire retardant concentrate composition includes magnesium chloride and an ammonium phosphate-based fire retardant where the concentrate contains less ammonia than ammonium phosphate-based fire retardants. Powder retardants may be prepared by combining a powder source of magnesium chloride along with the other components. The powder magnesium chloride may be provided as-is (i.e., as a powder) or may be prepared by milling flake magnesium chloride source.

### Flow Conditioner

The typical sources of magnesium chloride fire retardant, magnesium hexahydrate and anhydrous magnesium chloride, are hygroscopic. It is currently believed that due to its hygroscopic nature, particulate (e.g., powdered or flake) fire retardant concentrates including magnesium hexahydrate may become difficult to handle, mix, etc. over time. In particular, the powdered compositions are currently believed to be particularly prone to clumping. To address this concern, the concentrates of the present incorporate a flow conditioner. It currently believed the presence of the flow conditioner contributes advantageous properties. More particularly, it is currently believed the flow conditioner selected, its proportion, relative proportion to the fire retardant component, etc. contribute to the advantageous performance of the powder concentrates of the present invention. Typically, the flow conditioner has an average particle size of at least about 2 microns (μm), at least about 10 μm, at least about 25 μm, at least about 50 μm, at least about 75 μm, or at least about 100 μm. In certain embodiments, the flow conditioner has an average particle size of from about 2 μm to about 17 μm or from about 44 μm to about 105 μm. Additionally, or alternatively, such particle sizes may be based on the average particle size for a particular fraction of the flow conditioner, e.g., at least about or about 75 wt %, at least about or about 85 wt %, at least about or about 95 wt %, and/or at least about or about 99 wt %.

Typically, the flow conditioner is selected from the group consisting of phosphate flow conditioners, oxide flow conditioners, silicate flow conditioners, silica flow conditioners, cellulose containing flow conditioners, and combinations thereof.

Generally, the flow conditioner is present in a proportion of at least about 0.1 wt %, at least about 0.25 wt %, at least about 0.5 wt %, at least about 0.75 wt %, at least about 1 wt %, at least about 1.25 wt %, at least about 1.5 wt %, at least about 2 wt %, at least about 3 wt %, or even at least about 4 wt %. In various embodiments, the flow conditioner is present in a proportion of from about 0.25 wt % to about 5 wt %, from about 0.25 wt % to about 4 wt %, from about 0.25 wt % to about 3 wt %, from about 0.5 wt % to about 3 wt %, from about 0.5 wt % to about 2 wt %, from about 0.5 wt % to about 1.75 wt %, from about 0.75 wt % to about 1.5 wt %, or from about 1 wt % to about 1.5 wt %.

Overall, the flow conditioner may be present within a concentration range determined by a variety of lower limits (at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, or at least about 1 wt %) and upper limits (less than about 3 wt %, less than about 2.5 wt %, less than about 2 wt %, less than about 1.5 wt %, or even less than about 1 wt %).

Suitable phosphate flow conditioners are selected from the group consisting of tricalcium phosphate, magnesium phosphate, dimagnesium phosphate, trimagnesium phosphate, calcium phosphate, dicalcium phosphate, tricalcium phosphate, sodium aluminum phosphate, and combinations thereof. In various embodiments, the phosphate flow conditioner is tricalcium phosphate.

Suitable oxide flow conditioners include magnesium oxide, sodium dioxide, calcium oxide, silicon dioxide, and combinations thereof. In various embodiments, the flow conditioner is magnesium oxide. In certain embodiments, the flow conditioner comprises silicon dioxide. Silica dioxide-containing flow conditioners include silicas such as untreated fumes silica and micronized silica. Options of commercially available sources of flow conditioner include the following silicon dioxide flow conditioners: ZEOFREE 80, 110SD, 200, 5161, 5162, 265, 5191, 5193, and 5170.

Suitable silicate flow conditioners may be selected from the group consisting of calcium silicate, calcium aluminosilicate, calcium aluminum silicate, aluminum silicate, sodium silicate, sodium aluminum silicate, trisilicate, magnesium silicate, magnesium trisilicate, potassium aluminum silicate, and combinations thereof. In various embodiments, the silicate flow conditioner is selected from the group consisting of calcium silicate, aluminum silicate, sodium silicate, and combinations thereof. In various other embodiments, the flow conditioner is selected from sodium aluminosilicate, calcium silicate, aluminum silicate, and combinations thereof. Certain embodiments include calcium silicate as the flow conditioner. Options of commercially available calcium silicate flow conditioners include: HUBERSORB 5121, 250, and 600. Options of commercially available sodium aluminosilicate flow conditioners include: ZEOLEX 7, 201, 23A, and 7A.

Suitable cellulose containing flow conditioners are selected from the group consisting of ground rice hulls, a starch selected from potato, tapioca, and corn, bamboo powder, bamboo fiber, wheat powder, wheat fiber, oat powder, oat fiber, and combinations thereof. In certain embodiments, the flow conditioner comprises ground rice hulls.

In accordance with various embodiments of the present invention, the compositions may contain the flow conditioner and magnesium chloride at a weight ratio of from about 1:50 to about 1:75. Generally, the flow conditioner and magnesium chloride fire retardant is present at a weight ratio of from about 1:55 to about 1:70, from about 1:60 to about 1:70, or from about 1:65 to about 1:70.

### Thickener

The concentrate compositions of the present invention further comprise one or more thickeners. Representative examples of thickeners include xanthan gum, rhamsan gum, welan gum, diutan gum, guar gum, and mixtures thereof. In certain embodiments, the thickener is xanthan gum.

The thickener is typically present in a proportion of at least about 1 wt %, at least about 1.5 wt %, at least about 1.75 wt %, at least about 2 wt %, or at least about 2.5 wt %. Often, the thickener is present in a proportion of from about 1 wt % to about 8 wt %, 1.5 wt % to about 8 wt %, from about 1.75 wt % to about 8 wt %, from about 1.5 wt % to about 5 wt %, from about 1.5 wt % to about 3 wt %, from about 2 wt % to about 3 wt %, or from about 2.25 wt % to about 2.75 wt % (e.g., about 2.3 wt % or about 2.5 wt %).

### Corrosion Inhibitor

In various embodiments, the concentrates of the present invention further comprise a corrosion inhibitor.

The corrosion inhibitor may comprise an azole corrosion inhibitor. In certain embodiments, the azole corrosion inhibitor comprises tolytriazole and/or benzotriazole. Often, the azole corrosion inhibitor comprises tolytriazole. In certain embodiments, the amount of the azole corrosion inhibitor is from about 0.01% to about 2.0% by weight of the total concentrate concentration. In certain embodiments, the amount of the azole corrosion inhibitor is from about 0.05% to about 0.3% by weight of the total concentrate concentration. In certain embodiments, the amount of the azole corrosion inhibitor of is from any of about 0.01%, 0.05%, 0.1%, 0.2%, 0.3%, 0.4%, or 0.5% to any of about 0.05%, 0.1%, 0.2%, 0.3%, 0.5%, 0.6%, 0.7%, 0.8%, 0.9%, 1.0%, or 2.0% by weight of the total concentrate composition.

The corrosion inhibitor may also comprise a molybdate corrosion inhibitor. In certain embodiments, the corrosion inhibitor system comprises anhydrous sodium molybdate, its dihydrate, or mixtures thereof. In certain embodiments, the amount of anhydrous sodium molybdate, its dihydrate, and mixtures thereof is from about 0.01% to about 2.0% by weight of the total concentrate concentration. In certain embodiments, the amount of anhydrous sodium molybdate, its dihydrate, mixtures thereof is from about 0.05% to about 0.3% by weight of the total concentrate concentration. In certain embodiments, the amount of anhydrous sodium molybdate, its dihydrate, and mixtures thereof is from any of about 0.01%, 0.05%, 0.1%, 0.2%, 0.3%, 0.4%, 0.5%, 0.55% to any of about 0.05%, 0.1%, 0.2%, 0.3%, 0.5%, 0.6%, 0.7%, 0.8%, 0.9%, 1.0%, or 2.0% by weight of the total concentrate composition.

The corrosion inhibitor may also comprise an azole corrosion inhibitor and a molybdate corrosion inhibitor in accordance with the foregoing discussion for the individual corrosion inhibitors.

### Pigments/Dyes/Opacifiers

Generally, the concentrates of the present invention may be uncolored, include a pigment (e.g., iron oxide), or be colored with a fugitive pigment. A fugitive color system may be present in a concentration of from about 1 wt % to about 3.5 wt %, from about 1.5 wt % to about 3.5 wt % (e.g., about 1.7 wt %).

In certain aspects, the pigment or dye comprises red iron oxide, brown iron oxide, titanium dioxide or a fugitive pigment or dye. In some embodiments, the pigment or dye can comprise a fugitive color system.

In some embodiments, the fugitive color system comprises a fugitive pigment and a water insoluble opaque material (e.g., an opacifier such as zinc ferrite).

Suitable color systems are described in U.S. Ser. No. 16/784,913 (US 2020/024290 A1) and U.S. Pat. No. 11,142,698 the entire contents of which are incorporated herein by reference for all relevant purposes.

Typically, any dye or colorant is present in the concentrate at a concentration of from about 0.15 wt % to about 0.35 wt %, or about 0.15 wt % of the concentrate. For example, iron oxide may be present in a concentration of from about 0.15 wt % to about 1.5 wt %, or from about 0.15 wt % to about 0.35 wt %.

For example, suitable fugitive pigment color systems include those described in U.S. Pat. No. 11,142,698, the entire contents of which are incorporated by reference herein for all relevant purposes.

### Surfactant

Along with the components listed above, the concentrates of the present invention may optionally further include a surfactant. Typically, any surfactant constitutes from about 0.10 wt % to about 0.50 wt %, or from about 0.10 wt % to about 0.15 wt % (e.g., about 0.10 wt % of the concentrate).

### Particulate Concentrates

Various aspects of the present invention are directed to particulate fire retardants. Suitable particulates may be in a variety of forms, including powder particulates, flake particulates, and mixtures thereof. Typically, the particulate fire retardant is in powder form. Powders may also be identified visually, texturally, or a combination thereof.

It is to be understood that powder fire retardants refer to a fire retardant that is predominantly, mostly all, or nearly all in powder form as identified by any of the methods and/or properties detailed herein. In certain embodiments, therefore, the fire retardant includes powders and flakes, while in others the retardant composition consists essentially of or consists of powder.

Powder fire retardants of the present invention may be characterized by one or more particle size features. For example, in various embodiments, the powder fire retardant exhibits a mean (average) particle size (μm) of from about 600 μm to about 800 μm, from about 700 μm to about 800 μm (e.g., about 750 μm); and/or a median particle size of from about 500 μm to about 700 μm, from about 550 μm to about 650 μm (e.g., about 600 μm); and/or a d10 particle size of from about 75 μm to about 125 μm (e.g., about 100 μm); and/or a d50 particle size of from about 500 μm to about 700 μm, from about 550 μm to about 650 (e.g., about 600 μm); and/or a d90 particle size of from about 1250 μm to about 1750 μm, or from about 1400 μm to about 1650 μm (e.g., about 1600 μm).

As detailed below, one advantage of the particulate (powder) retardants of the present invention is their suitability for storage without significant changes in water content, flow properties, etc. In particular, the compositions are suitable for storage of a large, bulk sample without any significant changes in the properties.

More generally, the particulate concentrates of the present invention may be characterized as flowable concentrates indicating suitability for storage, processing etc. While much of the following discussion refers to “powder” concentrates, it is to be understood the discussion applies as well to concentrates properly referred to as particulate and which may also include flakes or other solid forms along with powder.

The powder concentrates of the present invention may be subjected to flow testing and characterized by the results of their testing in accordance with ASTM (D-6128-16) (i.e., the Jenike method) to assist in determining whether the powders will provide effective flow properties, handling properties, etc.

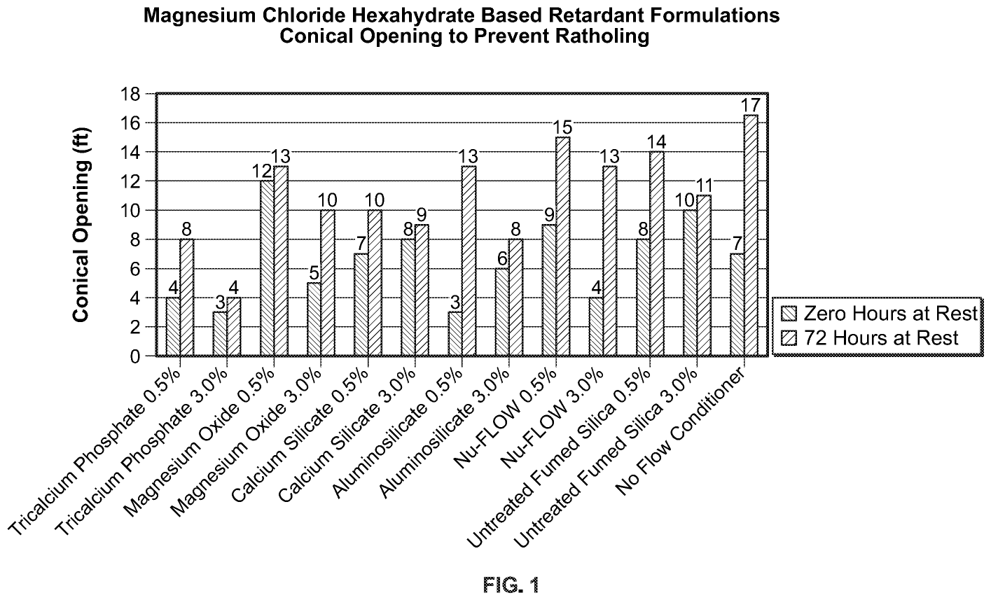

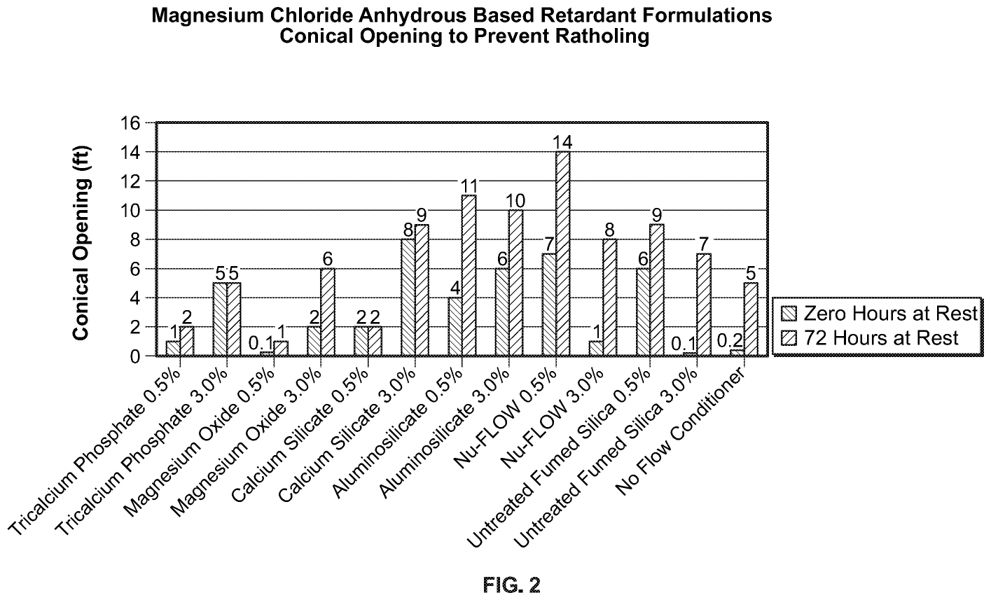

One flow testing property indicative of suitability for bulk storage is performance of the material when flowing in a funnel flow pattern, which is referred to as ratholing. Ratholing causes a funnel flow effect, where the powder flows freely above the outlet but then stops as the compacted powder is held in the silo or hopper. One aspect of the flow testing according to the Jenike method is determining the size of the conical opening that will prevent ratholing, i.e., the size of the conical opening that will collapse a rathole. Example 2 (FIGS. 1 and 2) describes the results of testing for this property for various flow conditioners at different concentrations along with magnesium chloride hexahydrate and magnesium chloride anhydrous.

As shown in FIG. 1, concentrates of the present invention may be characterized by ratholing results (conical opening, ft) of from about 4 ft to about 12 ft for magnesium chloride hexahydrate (zero hours at rest) for the flow conditioners present at approximately 0.5 wt %; and for the flow conditioners present at approximately 3.0 wt % of from about 3 ft to about 10 ft. The concentrates may be further characterized by results of from about 8 ft to about 15 ft after 72 hours of rest for the flow conditioners at approximately 0.5 wt % and for the flow conditioner at approximately 3 wt % of from about 4 ft to about 14 ft.

As shown in FIG. 2, concentrates of the present invention may be characterized by ratholing results (conical opening, ft) for magnesium chloride anhydrous (zero hours at rest) for the flow conditioners present at approximately 0.5 wt % of from about 0.1 ft to about 7 ft; and for the flow conditioners present at approximately 3.0 wt % of from about 2 ft to about 8 ft. The concentrates may be further characterized by the results after 72 hours of rest for the flow conditioners at approximately 0.5 wt % of from about 1 ft to about 14 ft and for the flow conditioner at approximately 3 wt % of from about 5 ft to about 10 ft.

Further, the unconfined yield strength may be measured, which is an indicator of a material's propensity to block and gain cohesive strength over time. Material having high unconfined yield strength would be considered worse flowing. This yield strength may be measured at a time zero and after storage. Samples of powder concentrates of the present invention can be subjected to flow testing to determine funnel flow properties and unconfined yield strength.

Powder concentrates of the present invention may overall exhibit an unconfined yield strength of from about 45 to about 245 pounds per square foot (psf), including for those based on magnesium chloride hexahydrate. Other concentrates may exhibit an unconfined yield strength of from about 5 psf to about 225 psf, including for those based on magnesium chloride anhydrous.

For classification of the powders based on their “flowability,” one property that can be measured is the FF-value, a dimensionless parameter determined in connection with the ASTM Jenike method testing. Generally, improved flowability is observed with a higher FF-value. Following are general categories of flowability based on the FF-value: FF<2 (very cohesive and non-flowing); 2<FF<4 (cohesive); 4<FF<10 (easy-flowing); >10 (free-flowing).

Powder concentrates of the present invention have been observed to exhibit FF values indicating the sample as easy-flowing or free flowing. Without being bound to a particular theory, powder concentrates of the present invention have been observed to be free flowing when containing relatively low proportions of flow conditioner, e.g., less than about 3 wt %, less than about 2.5 wt %, less than about 2 wt %, less than about 1.5 wt %, or less than about 1 wt %. As noted, such upper limits of flow conditioner may be combined with any or all of the following lower limits of at least about 0.1 wt %, at least about 0.2 wt %, at least about 0.3 wt %, or at least about 0.5 wt %.

Flowability testing is typically conducted prior to and after storage for a certain period of time (e.g., multiple days including, for example, 72 hours) and under certain stress conditions. It is to be understood FF-values are a general guideline of flowability properties and may vary according to the particular features of the powder being tested and the particular testing conditions. One testing condition is the preshear normal stress to which the powder sample is subjected. Such stress can generally range within any range of values suitable for conducting the flowability testing. These values can range from, for example, 50 pounds per square foot (psf) to 300 psf (e.g., from about 100 to about 300 psf, from about 200 to about 300 psf, or from about 250 to abut 275 psf).

Overall, therefore, various embodiments of the powder concentrates of the present invention exhibit FF-values when subjected to flowability testing of at least about 4, at least about 10, at least about 15, at least about 20, at least about 25, at least about 30, at least about 35, or at least about 40. Other embodiments may exhibit even higher FF-values when subjected to flowability testing of at least about 45, at least about 50, at least about 55, at least about 60, at least about 65, at least about 70, at least about 75, at least about 80, at least about 85, at least about 90, or at least about 95.

Such results may be observed when tested under any of the conditions noted above, including the exemplary concentrations of flow conditioner and/or shear conditions.

Typically, the powder concentrates exhibit FF-values when subjected to flowability testing of at least about 4, at least about 10, at least about 15, at least about 20, at least about 25, at least about 30, at least about 35, at least about 40, at least about 45, at least about 50, at least about 55, at least about 60, at least about 65, at least about 70, at least about 75, at least about 80, at least about 85, at least about 90, or at least about 95. Such results have been observed for concentrates containing the flow conditioner at a concentration of from about 0.1 wt % to about 3 wt %, or from about 0.5 wt % to about 3 wt %, e.g., about 0.5 wt % or about 3 wt %.

In certain such embodiments, the flow conditioner is present at a concentration from about 0.1 wt % to about 1 wt %. Further in accordance with such embodiments, the FF-value may be at least about 30, at least about 35, at least about 40, at least about 45, at least about 50, at least about 55, at least about 60, at least about 65, at least about 70, at least about 75, at least about 80, at least about 85, at least about 90, or at least about 95. Such properties may be present when the powders are tested under the above shear conditions including, for example, from 250 psf to 300 psf.

The flow conditioner for concentrates exhibiting such properties may generally be elected from those listed herein. In various embodiments where the concentrate exhibits the listed flowability features, the flow conditioner is selected from the group consisting of tricalcium phosphate, magnesium oxide, and magnesium silicate.

Typically, a majority or a predominant portion of the powder fire retardant exhibits one or more of the above particle size properties and/or properties as determined by flow testing. More typically, at least about 90 wt %, at least about 95 wt %, or at least about 99 wt % of the powder fire retardant exhibits any or all of the above properties.

In various embodiments, powder concentrates of the present invention may exhibit one or more of the following properties when subjected to testing in accordance with ASTM D-6128-6: an unconfined yield strength of at from about 0 to about 300 pounds per square foot (psf) when stored for approximately 72 hours under a pressure of approximately 270 psf; and/or an unconfined yield strength of at from about 10 to about 250 psf at a preshear normal stress of approximately 270 psf after storage for 72 hours; and/or an FF-value of at least about 3.5 at a preshear normal stress of approximately 270 psf; and/or a bulk density of at least about 30 (e.g., at least about 64).

Retardants of the present invention are often stored for significant periods of time prior to mixing with water to form a solution. Based on the hygroscopic nature of magnesium chloride, powder concentrates often encounter issues during storage due to attraction of moisture that results in clumping of the concentrates. Once clumping occurs, it is difficult to transport and mix the concentrates. It is currently believed that the presence of the flow conditioner allows for storage of the powder concentrates under typical storage conditions utilized in connection with other retardant concentrates (e.g., other powder retardants and/or other retardants such as ammonium phosphate based retardants).

Advantageously in accordance with the present invention, the powder concentrates of the present invention exhibit the properties described therein (e.g., flowability properties, etc.) after storage, including for long periods of up to a year or more. Additionally, or alternatively, it is currently believed the powder fire retardants exhibit similar moisture contents throughout and after storage. Various embodiments of the present invention, therefore, include powder fire retardant concentrates exhibiting any or all the properties described herein before and after storage for up to a year.

### Processes for Preparing Fire Retardant Solutions

As noted, the powder fire retardant concentrates of the present invention are currently believed to provide suitable corrosion properties to enable widespread use. In addition, the powders of the present invention are suitable for use in certain processes for preparing fire retardant solutions that embody improvements in terms of ease of processing, speed of processing, and the scale at which the powders can be diluted to provide fire retardant solutions for use. For example, there are known in the art specially manufactured storage and shipping containers including air-sealed bags having plastic liners and packaging including an air-permeable moisture barrier. Such air-sealed bags include those commercially available from Semi-Bulk Systems, Inc. (St. Louis, MO). These specially manufactured packaging materials are considered to be suitable in connection with liquid fire retardant concentrates and could also be used in connection with powder concentrates as well. Advantageously, however, the concentrates of the present invention do not require specially manufactured storage or shipping materials. This is a significant advantage as this allows the concentrates to be integrated into existing supply chains and transport systems.

As noted elsewhere herein, various aspects of the present invention involve preparation and usage of fire retardant solutions prepared by the dilution of powder concentrates of the present invention. Various aspects of the present invention thus involve processes incorporating one or more of the various steps required to prepare and use a fire retardant solution obtained from a concentrate of the present invention. It is currently believed the presence of the flow conditioner in the concentrate of the present invention provides one or more advantageous properties in this regard.

Generally, in accordance with the present invention, the powder concentrates are suitable for introduction into a vessel containing the dilution water by flowing the powder into the vessel at a desired rate depending on the desired rate of production of fire retardant solution.

For example, various processes involve providing a water storage tank and a fire retardant concentrate storage tank. Typically, such methods involve conveying via a suitable conduit water from the storage tank to a vessel for storing and/or dispensing the fire retardant solution; and conveying via a suitable conduit fire retardant concentrate from the storage tank into the conduit for conveying the water to the vessel. Combining the water and fire retardant concentrate in this manner provided mixing of the concentrate and water to form the fire retardant solution. In various embodiments, the fire retardant concentrate is conveyed from its storage tank to be combined with water via compressed air; or via a pressure difference between the conduit for conveying the water and the fire retardant concentrate storage tank.

Various processes of the present invention involve providing the desired solution at relatively high outputs. Such production may generally be achieved by continuously combining the powder fire retardant concentrate with water. For example, certain embodiments comprise continuously introducing a powder fire retardant concentrate into a vessel for dilution with water and forming the fire retardant solution, and continuously mixing the powder fire retardant concentrate with the water for a mixing period. Advantageous outputs of fire retardant solution may be provided by such methods including, for example, at least about 50 pounds (lbs) per minute, at least about 100 lbs per minute, at least about 200 lbs per minute, at least about 300 lbs per minute, at least about 350 lbs per minute, at least about 400 lbs per minute, at least about 500 lbs per minute, at least about 600 lbs per minute, at least about 700 lbs per minute, at least about 800 lbs per minutes, at least about 900 lbs per minute, at least about 1000 (lbs) per minute, at least about 1500 lbs per minute, or at least about 2000 lbs per minute.

Further in accordance with the present invention it is currently believed the present concentrates are suitable for use in mixing at typical mix rates that provide solutions of suitable viscosity for use. For example, the powder fire retardant concentrate may be combined with water at a dilution rate of from about 0.9 lbs to about 2.0 lbs concentrate per gallon water (e.g., about 0.9 lbs to about 1.5 lbs concentrate per gallon water), and provide a solution that exhibits a viscosity of from about 100 centipoise (cP) to about 1500 cP.

### Fire Retardant Solutions

Provided for herein are fire-retardant solutions prepared by mixing a fire-retardant concentrate composition, as described herein, with water to form an aqueous solution.

In certain embodiments, the solution is prepared by combining at least about 1.0 pound (lb.), at least about 1.5 lbs., or at least 2 lbs. of fire retardant concentrate per gallon of water.

In certain embodiments, the fire-retardant solution exhibits a viscosity in the range of from about 100 cPs to about 1500 cPs, from about 100 cPs to about 1000 cps, or from about 100 cPs to about 800 cPs, or from about 100 cPs to about 300 cPs when measured in accordance with Specification 5100-304d, January 2020, including any and all amendments.

Fire retardants of the present invention are suitable for ground application and aerial application. Ground applied retardants provide effective, pinpoint performance, cost-effective placement and the ability to apply the retardant under all weather conditions, and 24 hours per day. In particular, the fire retardants are suitable for use in connection with equipment commonly known for use in connection with PHOS-CHEK long-term retardant that has been applied for over 50 years, including by fire engine, water tender and custom ground application equipment. For example, the retardant can be applied by a variety of ground application methods including, for example, ground engines, brush trucks, water tenders, hydro-seeders, various vehicles (e.g., ATVs, UTVs, RTVs, and MOHUVs), backpack pumps, slip-on multi-agent delivery systems, and custom fabricated ground applied equipment. In this manner, the fire retardants are suitable for use in preventative and pretreatment methods in connection with a variety of environments including, for example, airports, and agricultural operations.

Powdered fire retardant can be stored using a vessel that is or can be in fluid flow communication with a source of water for mixing and/or for a vessel for storage and/or transport of the mixed retardant. Suitable containers for storage include those generally known for use in connection with bulk powders, powdered ingredients, etc. including, for example, “bulk bags” as commonly known in the art. Generally, the retardant is removed from the storage bin via a pressure differential to be mixed with water in a vessel that is in fluid flow communication with the storage vessel. The mixing vessel contains or is in fluid flow communication with the source of water. The mixed retardant is formed within the mixing vessel. The mixing vessel can then be either a storage vessel or a transport vessel. For example, the powder retardant can be removed from the storage vessel to be mixed in a tank that is part of a vehicle used in a MRB for use in ground of aerial application operations. It is to be understood that reference to a mixed retardant contemplated a partially or fully diluted concentrate and, this, in the latter instance would indicate a fire retardant solution.

Overall, the powder concentrates are suitable for mixing with water to provide a final mixed retardant for application. Generally, the power retardant can be mixed at a rate of approximately 1 pound retardant per approximately 1 gallon of water. For example, a 50 lb containing of powder retardant be combined with approximately 50 gallons to provide approximately 50 pounds of mixed retardant.

A typical weight (pounds per gallon, lb/gal) of mixed retardant can be from about 8 to about 10 lb/gal. Typical specific gravities of the mixed retardant are from about 1 to about 1.1. Further, typical viscosities of the mixed retardant is from about 100 centipoise to about 400 centipoise (cP). Advantageously, such viscosities are obtained from the powder retardants of the present invention without significant effort to deal with clumping or agglomeration based on accumulation of water during storage. Various embodiments and aspects of the invention thus involve preparing a mixed retardant from a powder retardant following storage in the absence of any mechanical or physical manipulation of the retardant of the retardant prior to mixing with water (e.g., to remove clumps). That is, the stored powder retardant is simply mixed with water without any additional manipulation in order form the mixed retardant.

In view thereof, various embodiments and aspects of the present invention are directed to a stored fire retardant that exhibits any or all of the properties defined herein but with minimal, if any variation in any of these properties. In this regard and the remainder of the present discussion, it is to be understood that reference to storage or a storage period may include storing for a month, two or more months, three months, six months, or even more (e.g., a year or even longer). One important property of the fire retardants of the present disclosure is suitability for use with existing and known equipment, with existing supply chains, etc. For example, conventional powder retardants can be stored in containers known for use in powders referred to as “bulk bags” including semi-bulk packaging (e.g., for use in connection with approximately 2000 lb loads or samples of powder). The retardants of the present invention can be stored in such containers and remain ready for preparation of a mixed retardant. Suitable semi-bulk packaging includes AIR PALLET bulk bags suitable for use in connection with applicable filling and unloading systems. Suitable unloading systems include gravity discharge systems and systems operated under pressure. It is currently believed the powder concentrates of the present invention are suitable for use in connection with such systems and, therefore, are suitable for use in existing storage, transport, and mixing systems.

As noted, retardants of the present disclosure are also suitable for aerial application, including helicopters (fixed tank and bucket), large airtankers, very large air tankers (VLAT), and single engine airtanker support (SEAT). In connection therewith, the fire retardant can be supplied via a fixed base of operations or a mobile retardant base (MRB) where the retardant is supplied to the appropriate aircraft for aerial application. Advantageously, the powder retardants are currently believed to be suitable for transport on a bulk scale given the flowability, strength, etc. properties discussed elsewhere herein. That is, the retardant can be delivered to any base for mixing, mobile or otherwise using standard transport equipment used with other retardants.

In accordance with the foregoing and the remainder of the present discussion (e.g., the appended claims), it is to be understood that reference to a sample, including a bulk sample may include samples of more than about 100 lbs, more than about 500 lbs, more than about 1000 lbs, or even more than about 2000 lbs. Such samples are currently believed the meet and/or exhibit the criteria listed herein.

### Methods of Combatting Fires

Various aspects of the present invention are directed to methods of combatting a wildfire by applying a fire-retardant solution prepared from a concentrate of the present invention described anywhere herein for the purpose of suppressing, containing, controlling, or extinguishing, etc., a wildfire.

In certain embodiments, the fire-retardant solution is applied directly onto a flaming fuel. In other embodiments, the fire-retardant solution is applied indirectly, e.g., in front of or parallel to the moving fire front. The distance between the advancing fire and the retardant fire-break depends on the rate that the solution can be applied, the rate of spread of the moving fire front, and the presence or absence of a natural fuel break identified by changes in the geometry of the ground being threatened. In certain embodiments, the fire-retardant solution is applied from a ground platform such as a fire-engine. In certain embodiments, the fire-retardant solution is applied from an aerial platform such as a fixed-wing aircraft or a rotary-wing aircraft. For example, in certain embodiments, the fire-retardant solution is applied from a rotary-wing aircraft such as a helicopter utilizing a bucket which is slung below the helicopter and in other embodiments the fire-retardant solution is contained within tanks mounted in or attached externally to the helicopter. In other embodiments, the fire retardant solution is applied from a mix of all of those listed vehicles or platforms. Obviously, the safety of the solution relative to aircraft corrosion and fouling of critical components must be greater when the solution is within or in contact with the aircraft.

### Liquid Fire Retardant Concentrates

The present invention also includes liquid fire retardant concentrates prepared by diluting the powder concentrates described herein to provide a liquid fire retardant concentrate Given that such concentrates involve partial dilution prior to forming the fire retardant solution for use, they may be termed intermediate liquid concentrates. Such concentrates typically contain from about 10 to about 50% by weight, from about 30% to about 50%, or from about 40% to about 50% by weight water.

Having described the invention in detail, it will be apparent that modifications and variations are possible without departing from the scope of the invention defined in the appended claims.

### EXAMPLES

The following non-limiting examples are provided to further illustrate the present invention.

### Example 1

The following table details exemplary magnesium chloride hexahydrate formulations containing various flow conditioners.

| FORMULATION | |
|---|---|
| Raw Material/Source | wt. % |
| MgCl₂•6H₂O | 92.00-95.00 |
| Thickener | 0.75-8.00 |
| Fugitive pigment | 1.00-3.50 |
| Pigment | 0.15-1.50 |
| Corrosion Inhibitor | 0.10-0.50 |
| Corrosion Inhibitor | 0.10-0.50 |
| Surfactant | 0.10-0.50 |
| Flow Conditioners | 0.5-3.0 |
| Magnesium Oxide | |
| Calcium Silicate | |
| Aluminosilicate | |
| Ground rice hulls/fiber | |
| Untreated FUMED SILICA | |

The magnesium chloride hexahydrate exhibited the following properties:

Magnesium Chloride hexahydrate,

| | |
|---|---|
| % Moisture | 0.32 |
| Particle Size, μm | |
| Mean | 739 |
| Median | 605 |
| d10 | 112 |
| d50 | 605 |
| d90 | 1597 |

### Example 2

The following example describes flow testing for magnesium chloride (anhydrous or hexahydrate) formulations. Compositions were prepared for each of the flow conditioners listed below, at concentrations of both 0.5 wt % and 3.0 wt % for each of the flow conditioners and with both MgCl₂·6H₂O and MgCl₂ (anhydrous).
Tricalcium phosphate (TCP)
Magnesium oxide
Calcium silicate
Aluminosilicate
Nu-FLOW (Ground rice hull based)
Fumed silica (untreated)
Control (no flow conditioner)

The results of testing in accordance with ASTM (D-6128-16) (i.e., the Jenike method) are discussed below.

TABLE 1
Particle Size Distribution (determined using a laser diffraction particle size analyzer) for MgCl₂•6H₂O formulations

| | Magnesium Chloride Hexahydrate Based Formulations Particle Size | | | | | | | | | | | | |
|---|---|---|---|---|---|---|---|---|---|---|---|---|---|
| | Flow Conditioners | | | | | | | | | | | | |
| | Tricalcium | | Magnesium | | Calcium | | | | | | Untreated | | No Flow |
| | Phosphate | | Oxide | | Silicate | | Aluminosilicate | | Nu-FLOW | | Fumed Silica | | Conditioner |
| — | 0.50% | 3.00% | 0.50% | 3.00% | 0.50% | 3.00% | 0.50% | 3.00% | 0.50% | 3.00% | 0.50% | 3.00% | 0.00% |
| Particle Size, μm | — | | | | | | | | | | | | |
| Mean | 1002 | 738 | 707 | 684 | 703 | 644 | 580 | 612 | 566 | 678 | 651 | 636 | 817 |
| Median | 997 | 595 | 565 | 542 | 548 | 566 | 473 | 544 | 481 | 548 | 520 | 469 | 728 |
| d10 | 281 | 46 | 69 | 71 | 59 | 57 | 37 | 52 | 50 | 54 | 33 | 22 | 60 |
| d50 | 997 | 595 | 565 | 542 | 548 | 566 | 473 | 544 | 481 | 548 | 520 | 469 | 728 |
| d90 | 1777 | 1644 | 1585 | 1555 | 1615 | 1301 | 1333 | 1290 | 1245 | 1552 | 1529 | 1600 | 1709 |

TABLE 2
Particle Size Distribution (determined using a laser diffraction particle size analyzer) for MgCl₂ (anhydrous) formulations

| | Magnesium Chloride Anhydrous Based Formulations Particle Size | | | | | | | | | | | | |
|---|---|---|---|---|---|---|---|---|---|---|---|---|---|
| | Flow Conditioners | | | | | | | | | | | | |
| | Tricalcium | | Magnesium | | Calcium | | | | | | Untreated | | No Flow |
| — | Phosphate | | Oxide | | Silicate | | Aluminosilicate | | Nu-FLOW | | Fumed Silica | | Conditioner |
| Particle Size, μm | 0.50% | 3.00% | 0.50% | 3.00% | 0.50% | 3.00% | 0.50% | 3.00% | 0.50% | 3.00% | 0.50% | 3.00% | 0.00% |
| Mean | 532 | 471 | 484 | 538 | 571 | 597 | 532 | 481 | 473 | 467 | 475 | 437 | 463 |
| Median | 428 | 416 | 417 | 449 | 476 | 475 | 438 | 424 | 417 | 406 | 413 | 332 | 379 |
| d10 | 42 | 37 | 42 | 49 | 55 | 42 | 48 | 40 | 41 | 37 | 35 | 20 | 43 |
| d50 | 428 | 416 | 417 | 449 | 476 | 475 | 438 | 424 | 417 | 406 | 413 | 332 | 379 |
| d90 | 1176 | 981 | 1018 | 1166 | 1252 | 1419 | 1154 | 1003 | 986 | 986 | 1002 | 1026 | 1002 |

FIGS. 1 and 2 provide funnel flow testing results for the formulations tested at zero hours of rest and at 72 hours of rest. When material flows in a funnel flow pattern one concern that may be significant is ratholing. Ratholing causes a funnel flow effect, where the powder flows freely above the outlet but then stops as the compacted powder is held in the silo or hopper.

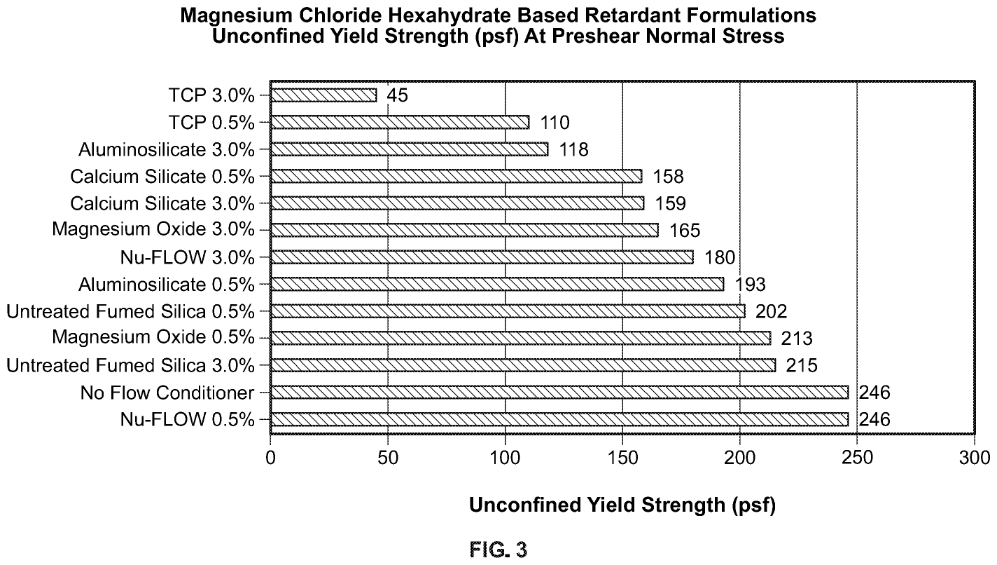

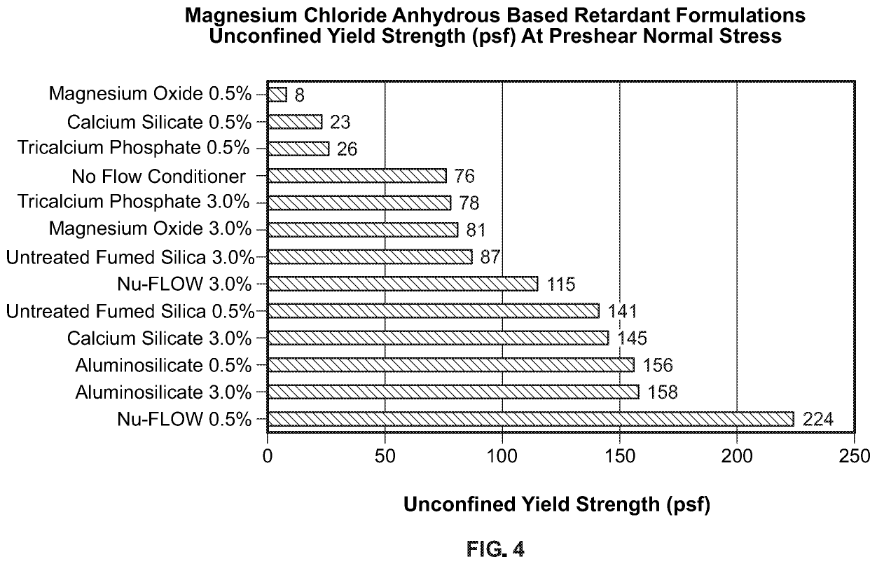

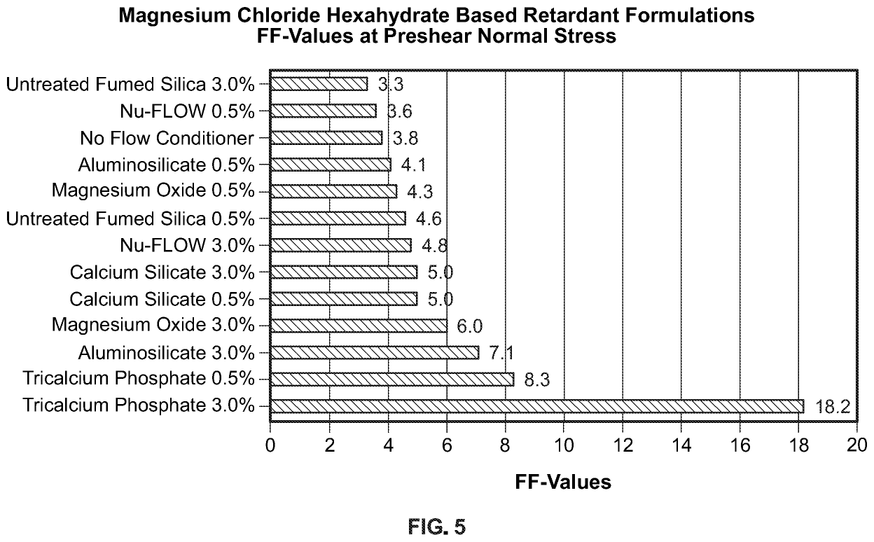

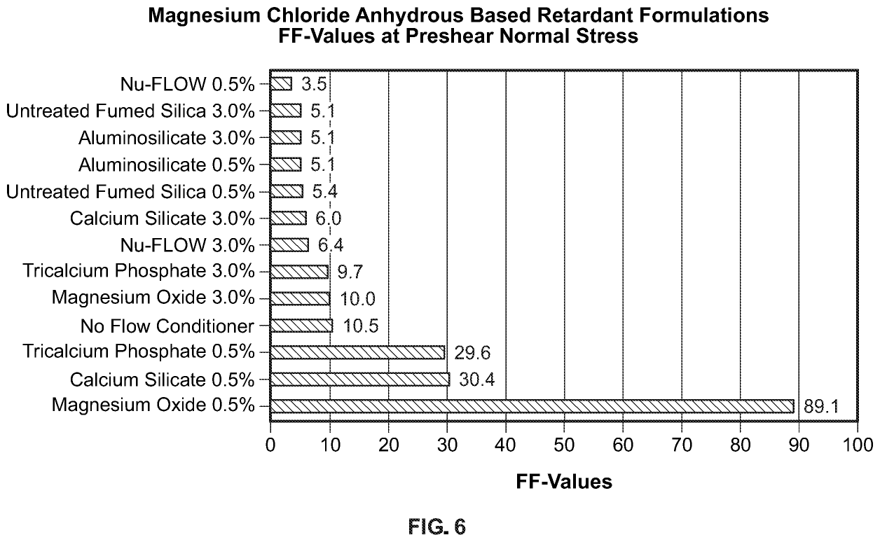

FIGS. 3 and 4 provide unconfined yield strength test results. Unconfined yield strength provides a general indication of each material's propensity to block and gain cohesive strength as a function of pressure over time. Generally, a material with higher unconfined yield strength would be considered worse flowing.

The flow function (FF-value) determined by the Jenike method is the general classification of the flowability of solids on the basis of cohesive strength. The lower the value indicates the worse flowing the material:

| FF-Value | Classification |
|---|---|
| FF < 2 | Very cohesive and non-flowing |
| 2 < FF < 4 | Cohesive |
| 4 < FF < 10 | Easy-flowing |
| 10 < FF | Free-flowing |

Although general trends in flowability are observed based on the testing results, e.g., unconfined yield strength and FF-value, one result (e.g., a higher unconfined yield strength or lower FF-value) does not necessarily disqualify a formulation. All flow properties, including flow testing results, are to be considered in connection with selecting a powder formulation for use including, for example, ease in packaging, handling, processing, etc. Moreover, as noted herein formulations containing a combination of magnesium chloride anhydrous and hexahydrate are included in various aspects of the present invention. The current flow testing results are for either hexahydrate or anhydrous sources of magnesium chloride. Where combinations of magnesium chloride hexahydrate and anhydrous are being considered, therefore, one particular testing value for either along with particular flow conditioner would not necessarily considered to be determinative when developing or selecting a formulation.

### EMBODIMENTS

For additional illustration, further and preferred embodiments of the present invention are set forth below.

Embodiment A is directed to a powder fire retardant concentrate, the concentrate comprising: magnesium chloride hexahydrate (MgCl₂·H₂O), anhydrous magnesium chloride, or a combination thereof; a thickener selected from the group consisting of xanthan gum, rhamsan gum, welan gum, diutan gum, guar gum, and combinations thereof; a corrosion inhibitor selected from the group consisting of azole corrosion inhibitors, molybdate corrosion inhibitors, and combinations thereof; a surfactant; and a flow conditioner selected from the group consisting of phosphate flow conditioners, oxide flow conditioners, silicate flow conditioners, silica flow conditioners, cellulose containing flow conditioners, and combinations thereof.

Embodiment A1 is the concentrate of Embodiment A, wherein the concentrate comprises magnesium chloride hexahydrate (MgCl₂·H₂O).

Embodiment A2 is the concentrate of Embodiment A, wherein the concentrate comprises anhydrous magnesium chloride.

Embodiment A3 is the concentrate of Embodiment A, wherein the concentrate comprises magnesium chloride hexahydrate (MgCl₂·H₂O) and anhydrous magnesium chloride in a weight ratio of hexahydrate to anhydrous of at least about 50:50, at least about 60:40, at least about 70:30, at least about 80:20, at least about 90:10, or at least about 95:5.

Embodiment A4 is the concentrate of any of the preceding Embodiments, wherein the thickener constitutes from about 1.5 wt % to about 3.0 wt %, or about 2.3 wt % of the concentrate.

Embodiment A5 is the concentrate of any of the preceding Embodiments, the concentrate further comprising a pigment selected from the group consisting of red iron oxide, brown iron oxide, titanium dioxide, and combinations thereof.

Embodiment A6 is the concentrate of Embodiment A5, wherein the pigment constitutes from about 0.15 wt % to about 0.35 wt %, or about 0.15 wt % of the concentrate.

Embodiment A7 is the concentrate of any of the preceding Embodiments, wherein the corrosion inhibitor constitutes from about 0.2 wt % to about 0.55 wt %, or about 0.3 wt % of the concentrate.

Embodiment A8 is the concentrate of any of the preceding Embodiments, wherein the surfactant constitutes from about 0.10 wt % to about 0.15 wt %, or about 0.10 wt % of the concentrate.

Embodiment A9 is the concentrate of any of the preceding Embodiments, wherein the flow conditioner constitutes from about 0.5 wt % to about 3.0 wt % of the concentrate.

Embodiment A10 is the concentrate of any of the preceding Embodiments, wherein the concentrate further comprises a fugitive color system.

Embodiment A11 is the concentrate of Embodiment A10, wherein the fugitive color system comprises a fugitive pigment.

Embodiment A12 is the concentrate of Embodiment A10 or A11, wherein the fugitive color system comprises a fugitive pigment and a water insoluble opaque material.

Embodiment A13 is the concentrate of any of Embodiments A10 to A12, wherein the fugitive color system constitutes from about 1.5 wt % to about 3.5 wt %, or about 1.7 wt % of the concentrate.

Example embodiments have been provided so that this disclosure will be thorough, and will fully convey the scope to those who are skilled in the art. Numerous specific details are set forth such as examples of specific components, methods, etc. to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes and well-known technologies are not described in detail.

When introducing elements of the present disclosure or the preferred embodiments(s) thereof, the articles “a”, “an”, “the” and “said” are intended to mean that there are one or more of the elements. The terms “comprising”. “including” and “having” are intended to be inclusive and mean that there may be additional elements other than the listed elements. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element or component could be termed a second element or component without departing from the teachings of the example embodiments.

In view of the above, it will be seen that the several objects of the invention are achieved and other advantageous results attained.

As various changes could be made in the above without departing from the scope of the present disclosure, it is intended that all matter contained in the above description shall be interpreted as illustrative and not in a limiting sense.

Having described the present disclosure in detail, it will be apparent that modifications and variations are possible without departing from the scope of the present disclosure defined in the appended claims.

1. A powder fire retardant concentrate, the concentrate comprising:
a magnesium chloride fire retardant comprising magnesium chloride hexahydrate (MgCl₂·6H₂O) and/or anhydrous magnesium chloride, wherein the magnesium chloride fire retardant constitutes greater than 90 wt % of the concentrate;
a flow conditioner, wherein the flow conditioner comprises one or more selected from the group consisting of phosphate flow conditioners, oxide flow conditioners, silicate flow conditioners, silica flow conditioners, cellulose containing flow conditioners, and combinations thereof, wherein the flow conditioner constitutes from about 0.5 wt % to about 3.0 wt % of the concentrate; and
one or more components selected from a thickener, a corrosion inhibitor, and/or a surfactant.

2. A powder fire retardant concentrate, the concentrate comprising:
a magnesium chloride fire retardant comprising magnesium chloride hexahydrate (MgCl₂·6H₂O) and/or anhydrous magnesium chloride, wherein the magnesium chloride fire retardant constitutes greater than 90 wt % of the concentrate;
a flow conditioner, wherein the flow conditioner comprises one or more selected from the group consisting of phosphate flow conditioners, oxide flow conditioners, silicate flow conditioners, silica flow conditioners, cellulose containing flow conditioners, and combinations thereof, wherein the flow conditioner constitutes from about 0.5 wt % to about 3.0 wt % of the concentrate, wherein a sample of the retardant exhibits a flow-function (FF-value) when tested in accordance with ASTM D-6128-16 of at least about 4.

3. The fire retardant concentrate of claim 2, wherein the sample is more than about 100 lbs.

4. The fire retardant concentrate of claim 2, wherein the sample of the retardant exhibits a flow-function (FF-value) when tested in accordance with ASTM D-6128-16 at least about 12.

5. The fire retardant concentrate of claim 1, wherein the concentrate comprises magnesium chloride hexahydrate and magnesium chloride anhydrous.

6. The fire retardant concentrate of claim 5 wherein the weight ratio of magnesium chloride hexahydrate to magnesium chloride anhydrous is from about 20:80 to about 80:20.

7. The fire retardant concentrate of claim 2, wherein the flow conditioner comprises a phosphate flow conditioner selected from the group consisting of tricalcium phosphate, magnesium phosphate, dimagnesium phosphate, trimagnesium phosphate, calcium phosphate, dicalcium phosphate, tricalcium phosphate, sodium aluminum phosphate, and combinations thereof.

8. The fire retardant concentrate of claim 7, wherein the flow conditioner comprises tricalcium phosphate.

9. The fire retardant concentrate of claim 2, wherein the flow conditioner comprises an oxide flow conditioner selected from the group consisting of magnesium oxide, sodium dioxide, calcium oxide, silicon dioxide, and combinations thereof.

10. The fire retardant concentrate of claim 9, wherein the flow conditioner comprises silicon dioxide.

11. The fire retardant concentrate of claim 2, wherein the flow conditioner comprises a silicate flow conditioner selected from the group consisting of calcium silicate, calcium aluminosilicate, calcium aluminum silicate, aluminum silicate, sodium silicate, sodium aluminum silicate, trisilicate, magnesium silicate, magnesium trisilicate, potassium aluminum silicate, and combinations thereof.

12. The fire retardant concentrate of claim 11, wherein the flow conditioner comprises a silicate flow conditioner selected from the group consisting of calcium silicate, aluminum silicate, sodium silicate, and combinations thereof.

13. The fire retardant concentrate of claim 2, wherein the flow conditioner comprises a silica flow conditioner selected from the group consisting of untreated fumed silica, micronized silica, and combinations thereof.

14. The fire retardant concentrate of claim 2, wherein the flow conditioner comprises a cellulose containing flow conditioner selected from the group consisting of ground rice hulls, a starch selected from potato, tapioca, and corn, bamboo powder, bamboo fiber, wheat powder, wheat fiber, oat powder, oat fiber, and combinations thereof.

15. The fire retardant concentrate of claim 14 wherein the flow conditioner comprises ground rice hulls.

16. A powder fire retardant concentrate, the concentrate comprising:
a magnesium chloride fire retardant comprising magnesium chloride hexahydrate (MgCl₂·6H₂O) and/or anhydrous magnesium chloride, wherein the magnesium chloride fire retardant constitutes greater than 90 wt % of the concentrate;
a flow conditioner, wherein the flow conditioner comprises one or more selected from the group consisting of phosphate flow conditioners, oxide flow conditioners, silicate flow conditioners, silica flow conditioners, cellulose containing flow conditioners, and combinations thereof, wherein the flow conditioner constitutes from about 0.5 wt % to about 3.0 wt % of the concentrate, wherein the concentrate exhibits one or more of the following properties:
an unconfined yield strength of at from about 0 to about 300 pounds per square foot (lbs psf) when stored for approximately 72 hours under a pressure of approximately 270 psf; and/or
an unconfined yield strength of at from about 0 to about 300 lbs psf at a preshear normal stress of approximately 270 lbs psf after storage for 72 hours; and/or
an FF-value of at least about 3.5 at a preshear normal stress of approximately 270 lbs psf; and/or
a bulk density of at least about 30 when subjected to shear testing in accordance with ASTM D-6128-6.

17. A process for preparing a fire retardant solution, the process comprising:
continuously introducing a powder fire retardant concentrate into a vessel for dilution with water and forming the fire retardant solution, wherein the fire retardant concentrate is defined as set forth in any of the preceding claims; and
continuously mixing the powder fire retardant concentrate with the water for a mixing period, wherein the fire retardant solution is produced during the mixing period at a rate of at least about 100 pounds (lbs) per minute.

18. A process for preparing a fire retardant solution, the process comprising:
combining a powder fire retardant concentrate as set forth in claim 2 with water at a dilution rate of from about 0.9 lbs to about 2.0 lbs concentrate per gallon water, wherein the solution exhibits a viscosity of from about 100 centipoise (cP) to about 1500 cP.

19. A process for preparing a fire retardant solution, the process comprising:
providing a water storage tank;
providing a fire retardant concentrate storage tank, wherein the fire retardant concentrate is a powder as set forth in claim 2;
conveying via a suitable conduit water from the storage tank to a vessel for storing and/or dispensing the fire retardant solution; and
conveying via a suitable conduit fire retardant concentrate from the storage tank into the conduit for conveying the water to the vessel, thereby mixing the fire retardant concentrate and water, wherein:
the fire retardant concentrate is conveyed via compressed air; or
the fire retardant concentrate is conveyed via a pressure difference between the conduit for conveying the water and the fire retardant concentrate storage tank.

20. The fire retardant concentrate of claim 1, wherein:
the flow conditioner constitutes about 3.0 wt % of the concentrate;
the phosphate flow conditioners are selected from the group consisting of tricalcium phosphate, magnesium phosphate, dimagnesium phosphate, trimagnesium phosphate, calcium phosphate, dicalcium phosphate, tricalcium phosphate, sodium aluminum phosphate, and combinations thereof;
the oxide flow conditioners are selected from the group consisting of magnesium oxide, sodium dioxide, calcium oxide, silicon dioxide, and combinations thereof;
the silicate flow conditioners are selected from the group consisting of calcium silicate, calcium aluminosilicate, calcium aluminum silicate, aluminum silicate, sodium silicate, sodium aluminum silicate, trisilicate, magnesium silicate, magnesium trisilicate, potassium aluminum silicate, and combinations thereof;
the silica flow conditioners are selected from the group consisting of untreated fumed silica, micronized silica, and combinations thereof; and
the cellulose containing flow conditioners are selected from the group consisting of ground rice hulls, a starch selected from potato, tapioca, and corn, bamboo powder, bamboo fiber, wheat powder, wheat fiber, oat powder, oat fiber, and combinations thereof.

21. The fire retardant concentrate of claim 2, wherein:
the phosphate flow conditioners are selected from the group consisting of magnesium phosphate, dimagnesium phosphate, trimagnesium phosphate, calcium phosphate, dicalcium phosphate, tricalcium phosphate, sodium aluminum phosphate, and combinations thereof;
the oxide flow conditioners are selected from the group consisting of magnesium oxide, sodium dioxide, calcium oxide, silicon dioxide, and combinations thereof;
the silicate flow conditioners are selected from the group consisting of calcium silicate, calcium aluminosilicate, calcium aluminum silicate, aluminum silicate, sodium aluminum silicate, trisilicate, magnesium silicate, magnesium trisilicate, potassium aluminum silicate, and combinations thereof;
the silica flow conditioners are selected from the group consisting of untreated fumed silica, micronized silica, and combinations thereof; and
the cellulose containing flow conditioners are selected from the group consisting of ground rice hulls, a starch selected from potato, tapioca, and corn, bamboo powder, bamboo fiber, wheat powder, wheat fiber, oat powder, oat fiber, and combinations thereof.

22. The fire retardant concentrate of claim 16, wherein:
the phosphate flow conditioners are selected from the group consisting of tricalcium phosphate, magnesium phosphate, dimagnesium phosphate, trimagnesium phosphate, calcium phosphate, dicalcium phosphate, tricalcium phosphate, sodium aluminum phosphate, and combinations thereof;
the oxide flow conditioners are selected from the group consisting of magnesium oxide, sodium dioxide, calcium oxide, silicon dioxide, and combinations thereof;
the silicate flow conditioners are selected from the group consisting of calcium silicate, calcium aluminosilicate, calcium aluminum silicate, aluminum silicate, sodium silicate, sodium aluminum silicate, trisilicate, magnesium silicate, magnesium trisilicate, potassium aluminum silicate, and combinations thereof;
the silica flow conditioners are selected from the group consisting of untreated fumed silica, micronized silica, and combinations thereof; and
the cellulose containing flow conditioners are selected from the group consisting of ground rice hulls, a starch selected from potato, tapioca, and corn, bamboo powder, bamboo fiber, wheat powder, wheat fiber, oat powder, oat fiber, and combinations thereof.
